(19) United States
(12) Patent Application Publication
(10) Pub. No.: US 2011/0019107 A1
(43) Pub. Date: Jan. 27, 2011

(54) SYSTEM, METHOD AND APPARATUS FOR AUXILIARY USE OF INTERNAL SPEAKERS

(75) Inventors: Kenneth Lowe, San Juan Capistrano, CA (US); William Wang, Irvine, CA (US)

Correspondence Address: Documents and Design, LLC, 206 North Derby Lane, North Sioux City, SD, 57049, US

(73) Assignee: VIZIO Inc., Irvine, CA (US)

(21) Appl. No.: 12/509,031

(22) Filed: Jul. 24, 2009

(51) Int. Cl. H04N 5/60; H02B 1/00

(52) U.S. Cl. 348/738; 381/123; 348/E05.122

(57) ABSTRACT

An application for a system that has at least one internal speaker and an internal source of amplified audio interfaced to the internal speaker. The internal speaker is selectively disconnected from the internal source of amplified audio and connected to an external source of amplified audio. The selection is by, for example, a remote control directive, a switch or by detection of the external amplified audio.

### FIELD OF THE INVENTION

This invention relates to the field of devices with internal speakers and more particularly to a system for making the internal speakers available to external devices.

### BACKGROUND OF THE INVENTION

Devices such as monitors and televisions often have one or more internal speakers. Normally, the internal speakers are connected to an internal source of amplified sound and the speakers reproduce the amplified sound. For example, in a typical television, sound is received, either from an audio signal delivered to an input jack or an audio signal extracted from an audio/video signal. The audio signal is then amplified and delivered to one or more speakers to reproduce the sound at a level that is audible to a human ear.

In many situations, especially with high-end televisions, the consumer does not use the internal speakers. Instead, the audio signal is connected to one or more audio output jacks and the audio output jacks are connected to an external amplifier and the amplifier is connected to one or more external speakers. Alternately, when the sound comes from a source external to the television such as a disk player or a set-top-box, the audio signal is routed directly from the external source to the amplifier. In either case, when the sound is amplified by an amplifier external to the television, the speakers in the television are not used and sit idle.

In many external amplifier scenarios, the sound is provided in multiple channels such as 5.1 (5 main speakers consisting of left-front, right-front, left-back, right-back, center; plus one base speaker). In such systems, it is desirable to locate the center speaker as close to the display as possible since the center speaker usually reproduces sounds of people talking and by being local to the image of the people, this gives the impression that the talking is coming directly from the people. To such a goal, center speakers are often wide and short to fit on top of a conventional television, at least that of a cathode-ray tube (CRT) television. As televisions keep getting thinner (e.g., 1″ or less), it becomes more difficult to set the center speaker on top of the television. Alternately, the center speaker could be located beneath the television, but would have to be large enough to support the intended television and, since the width and location of mounting feet vary from television to television, the center speaker would have to be delivered in a range of sizes. Furthermore, this problem is further compounded when newer flat-screen televisions are mounted on a wall. This would require the center speaker also be mounted to the wall.

What is needed is a system that makes its internal speaker(s) available to external amplified audio, for example, the center channel of a multi-channel audio system.

### SUMMARY

The present invention includes a system such as a television that has at least one internal speaker and an internal source of amplified audio that is interfaced to the internal speaker. The internal speaker is selectively disconnected from the internal source of amplified audio and connected to an external source of amplified audio. The selection is by, for example, a remote control directive, a switch or by detection of the external amplified audio.

In one embodiment, a system for utilizing internal speakers is disclosed. The system has an internal source of amplified audio and at least one internal speaker. The system includes a device for selectively connecting the at least one internal speaker to either the internal source of amplified audio or an external source of amplified audio, the external source of amplified audio provided as an input to the system and a device for controlling the device for selectively connecting.

In another embodiment, a method of utilizing an internal speaker of a system is disclosed. The system has an external source of amplified audio. The method includes connecting the internal speaker to an output of a multiplexer, connecting an internal source of amplified audio to a first input of the multiplexer and connecting the internal source of amplified audio to a second input of the multiplexer. The multiplexer is controlled by a logic signal whereby when the logic signal is in a first logic state the multiplexer connects the internal speaker to the internal source of amplified audio and when the logic signal is in a second logic state, the multiplexer connects the internal speaker to the external source of amplified audio.

In another embodiment, a television system is disclosed including at least one internal speaker, an internal source of amplified audio, at least one multiplexer and a detector. Each of the multiplexers has an output and at least two inputs. The output is connected to one of the internal speakers, a first input of the multiplexer is connected to the internal source of amplified audio and a second input of the multiplexer is connected to an external source of amplified audio. The external source of amplified audio is provided as an input to the system. The detector has a detector input connected to the external source of amplified audio and a detector output connected to the multiplexer. The detector output controls the multiplexer such that at a first value of the detector output, the multiplexer connects the internal source of amplified audio to one of the at least one internal speaker and at a second value of the detector output, the multiplexer connects the external source of amplified audio to one of the at least one internal speaker.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of a monitor or television with speakers of the present invention.

FIG. 2 illustrates a schematic view of a monitor or television with externally accessible speakers of the present invention.

FIG. 3 illustrates a second schematic view of a monitor or television with externally accessible speakers and a means of detecting the presence of external amplified audio of the present invention.

FIG. 4 illustrates a schematic view of an exemplary detection circuit of the present invention.

FIG. 5 illustrates a schematic view of an exemplary speaker multiplexer of the present invention.

FIG. 6 illustrates a flow chart of the present invention.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures. The present invention applies to any system having internal speakers and an internal source of amplified audio. For simplicity and clarity, the invention is described using a television as an exemplary system, though other systems are anticipated, for example, a clock radio.

For simplicity, the speaker of the present invention is shown in the front facing surface of a television or monitor as shown in the figures. It is known in the industry to locate the speakers on any surface of the system or device (e.g., television) and, in some embodiments, to mount the speakers internally and provide a sound duct to channel the sound towards the viewer. Additionally, even when the speakers are located on the front bezel, it is possible to make it so they are not easily detectable by the human eye. All mounting arrangements of speakers on a system are anticipated by the present application.

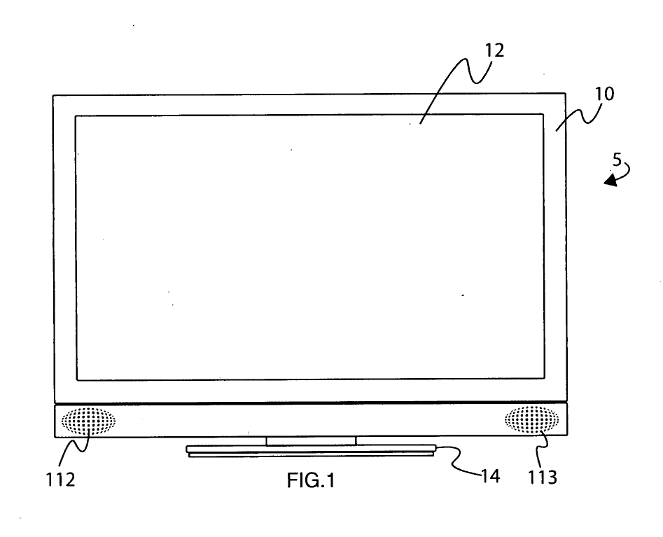

Referring to FIG. 1, a plan view of a monitor or television 5 with speakers 112/113 of the present invention will be described. The present invention is applicable to device that has internal speakers 112/113 and an internal source of amplified sound such as a monitor or television 5. Typically, the monitor or television has a display panel 12 such as a Liquid Crystal Display (LCD), Light Emitting Diode (LED) array, Cathode Ray Tube (CRT), Plasma panel, Organic Light Emitting Display (OLED) panel, etc. A bezel 10 covers the frame and electronics of the display panel 12. Many such monitors or televisions include a stand 14 that is, optionally, removable. Not visible, but within the monitor or television 5 is a source of amplified audio that is typically connected to the speaker(s) 112/113 for delivery of sound to a viewer's ears. Note that, although the present invention uses a monitor or television 5 as an example of a system that has internal speakers 112/113 and an internal source of amplified audio, many other systems have these features and the present invention anticipates many different systems that will integrate the present invention. Clock radios and boom boxes are examples of such systems.

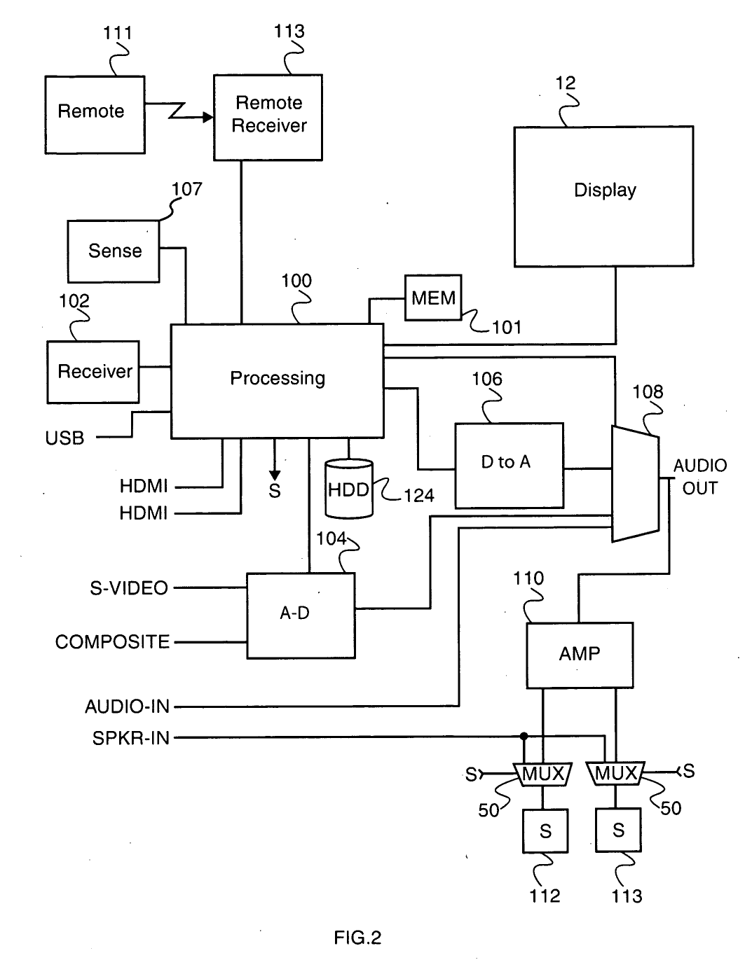

Referring to FIG. 2, a schematic view of a typical monitor or television 5 of the present invention will be described. This figure is intended as a representative schematic of a typical monitor or television 5 and in practice, some elements are not present in some monitor or television 5 and/or additional elements are present in some monitor or television 5. In this example, a display panel 12 is connected to a processing element 100. The display panel 12 is representative of any known display panel including, but not limited to, LCD display panels, Plasma display panels, OLED display panels, LED display panels and cathode ray tubes (CRTs).

The processing element 100 accepts video inputs and audio inputs selectively from a variety of sources including an internal television broadcast receiver 102, High-definition Media Inputs (HDMI), USB ports and an analog-to-digital converter 104. The analog-to-digital converter 104 accepts analog inputs from legacy video sources such as S-Video and Composite video and converts the analog video signal into a digital video signal before passing it to the processing element. The processing element controls the display of the video on the display panel 12.

Audio emanates from either the broadcast receiver 102, the legacy source(s) (e.g., S-Video) or discrete analog audio inputs (Audio-IN). If the audio source is digital, the processing element 100 routes the audio to a digital-to-analog converter 106 and then to an input of a multiplexer 108. The multiplexer 108, under control of the processing element 100, selects one of the audio sources and routes the selected audio to the audio output and an internal audio amplifier 110. The internal audio amplifier 110 amplifies the audio and delivers the amplified audio to internal speakers 112/113 through, in this embodiment, a speaker multiplexer 50.

The processing element 100 accepts commands from a remote control 111 through remote receiver 113. Although IR is often used to communicate commands from the remote control 111 to the remote receiver 113, any known wireless technology is anticipated for connecting the remote control 111 to the processing element 100 including, but not limited to, radio frequencies (e.g., Bluetooth), sound (e.g., ultrasonic) and other spectrums of light. Furthermore, it is anticipated that the wireless technology be either one way (unidirectional) from the remote 111 to the receiver 113 or bidirectional including a transmission path back to the remote control 111. When bidirectional, there are no limitations as to both directions utilizing the same wireless technology (e.g., the remote control 111 sends using IR and the television or monitor 5 sends using RF).

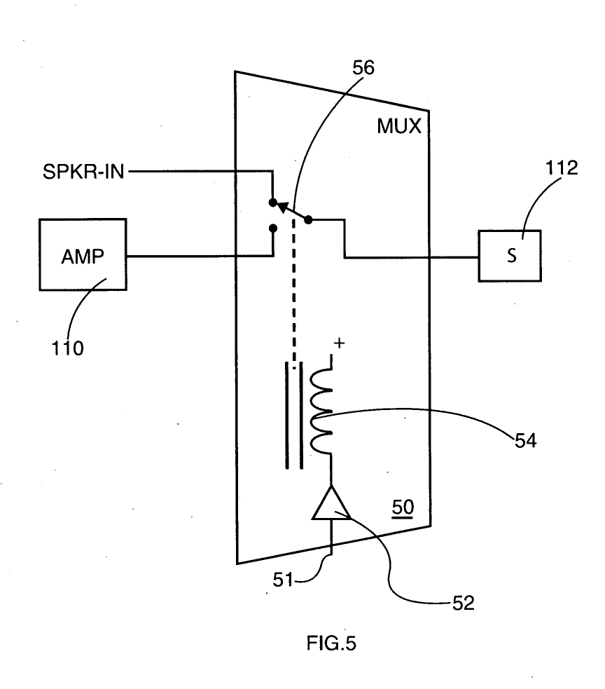

In this embodiment, upon reception of a command from the remote control 111 through the IR receiver 113 (for example), the processing element 100 changes the state of an output signal S. Signal S has at least two states. The output signal S is connected an input of the speaker multiplexers 50 (details shown in FIG. 5). When signal S is in a first state, the speaker multiplexers 50 route amplified audio signal from the amplifier 110 to the speakers 112/113. When signal S is in a second state, the speaker multiplexers 50 route the SPKR-IN signal to the speakers 112/113. In this way, under user selection, the internal speaker(s) 112/113 are made available to be connected to an external source of amplified audio (SPKR-IN). Although shown as a single SPKR-IN, it is anticipated that in an alternate embodiment, there are multiple SPKR-IN inputs, one for each internal speaker.

For completeness, in some embodiments, a light sensor 105 is interfaced to the processing element 100, for example, a photodiode. The light sensor 105 conveys a value representing the ambient light level in the vicinity of the front of the monitor or television 5. This value is used, for example, to vary the brightness of the display 12 and/or the illuminating elements 20 responsive to the ambient light present in front of the monitor or television 5.

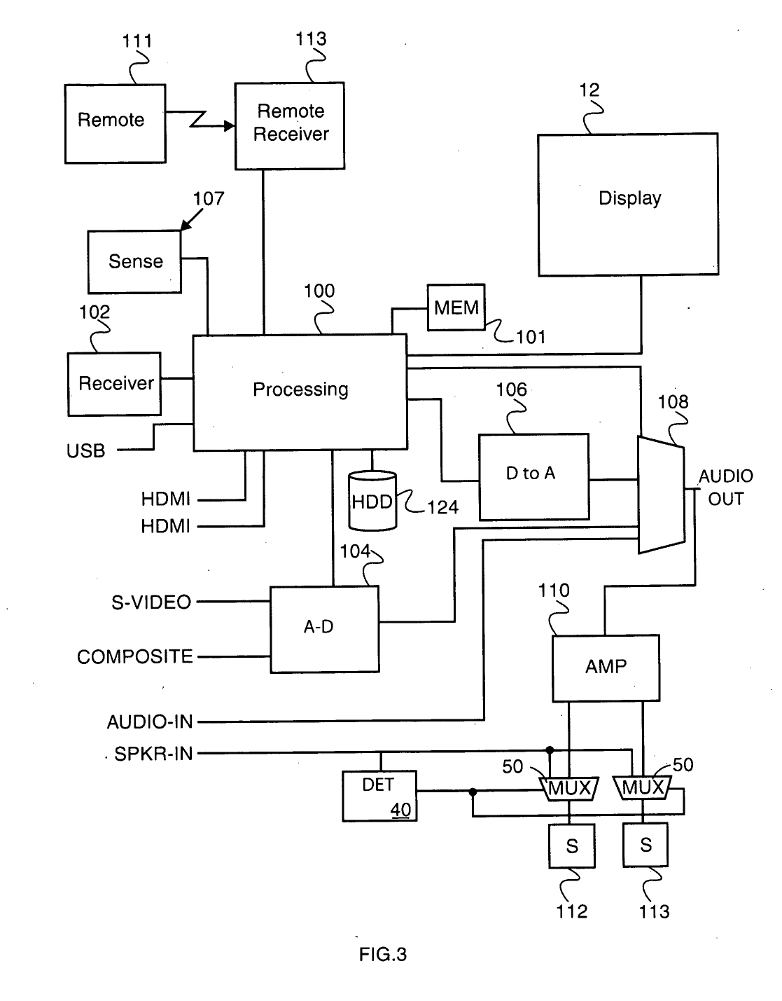

Referring to FIG. 3, a schematic view of a second typical monitor or television of the present invention will be described. This figure is intended as a representative schematic of a typical monitor or television 5 and in practice, some elements are not present in some monitor or television 5 and/or additional elements are present in some monitor or television 5. In this example, a display panel 12 is connected to a processing element 100. The display panel 12 is representative of any known display panel including, but not limited to, LCD display panels, Plasma display panels, OLED display panels, LED display panels and cathode ray tubes (CRTs).

The processing element 100 accepts video inputs and audio inputs selectively from a variety of sources including an internal television broadcast receiver 102, High-definition Media Inputs (HDMI), USB ports and an analog-to-digital converter 104. The analog-to-digital converter 104 accepts analog inputs from legacy video sources such as S-Video and Composite video and converts the analog video signal into a digital video signal before passing it to the processing element. The processing element controls the display of the video on the display panel 12.

Audio emanates from either the broadcast receiver 102, the legacy source (e.g., S-Video) or a discrete analog audio input (Audio-IN). If the audio source is digital, the processing element 100 routes the audio to a digital-to-analog converter 106 and then to an input of a multiplexer 108. The multiplexer 108, under control of the processing element 100, selects one of the audio sources and routes the selected audio to the audio output and an internal audio amplifier 110. The internal audio amplifier 110 amplifies the audio and delivers it to internal speakers 112/113 through one or more speaker multiplexer 50.

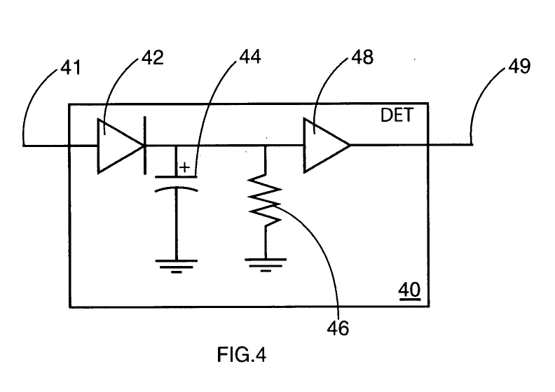

In this embodiment, a detector 40 is provided for detecting the presence of an audio signal from the SPKR-IN of sufficient level. The output 49 (see FIG. 4) of the detector 40 is normally at a first level. Upon detection of an amplified audio signal coming from SPKR-IN, the output of the detector 40 changes to a second level. The control inputs 51 (see FIG. 5) of the speaker multiplexers 50 are connected to and respond to the output 49 of the detector 40. When the input 51 of the speaker multiplexers 50 is at the first level, the internal amplified audio signal from the amplifier 110 is connected to the speakers 112/113. When the input 51 of the speaker multiplexers 50 is at the second level, the SPKR-IN signal is connected to the speakers 112/113. In this way, when an external audio signal is detected by the detector 40, the internal speaker(s) 112/113 are automatically available to the external source of amplified audio (SPKR-IN). Although shown as a single SPKR-IN, it is anticipated that, in an alternate embodiment, there are multiple SPKR-IN inputs, one for each internal speaker. In such, it is anticipated that the detector 40 includes logic to detect amplified audio on one or multiple SPKR-IN inputs.

Referring to FIG. 4, a schematic diagram of an exemplary detector 40 of the present invention will be described. This is an exemplary detector 40. Many other circuits are anticipated. It is also anticipated that, in some embodiments, the detector 40 includes filtering to detect a certain band and level of audio input on the SPKR-IN.

In this simplified detector 40, the input 41 of the detector 40 is connected to a diode 42. The diode 42 converts (detects) the alternating current (AC) of the SPKR-IN audio signal into a direct current (DC) potential and charges a capacitor 44. The capacitor 44 is connected to a buffer 48 (e.g., a Schmitt trigger) which has an input threshold. When the charge on the capacitor 44 is lower than the input threshold, the output 49 of the buffer 48 is in the first state. When the charge on the capacitor 44 reaches the input threshold, the output 49 of the buffer 48 changes to the second state. Therefore, when an audio signal of sufficient level is presented to the input 41, the capacitor 44 charges until it reaches the threshold voltage of the buffer 48, at which time the output 49 changes from the first state to the second state.

In some embodiments, a resistor 46 is provided to discharge the capacitor 44 after the audio signal abates. It is well known in the industry to select values of the resistor 46 and capacitor 44, in conjunction with the threshold of the buffer 48, to affect a timer, such that, during quiet passages of audio, the output 49 does not prematurely change from the first state to the second state. Therefore, when an audio signal at the input 41 abates, the capacitor 44 discharges through the resistor 46 until it falls below the threshold voltage of the buffer 48, at which time the output 49 changes from the second state back to the first state.

It is also anticipated that, when multiple SPKR-IN inputs are present, in some embodiments, multiple diodes 42 are connected to each creating a summing node. Furthermore, other components are anticipated to limit over voltages at the buffer 48 and voltage spikes, etc. It is also anticipated that, in some embodiments, the processing element 100 is configured to digitally perform the function of the detector 40.

Referring to FIG. 5, a schematic diagram of an exemplary speaker multiplexer 50 of the present invention will be described. This is an exemplary speaker multiplexer 50. Many other circuits are anticipated. It is also anticipated that, in some embodiments, the speaker multiplexer 50 includes dummy loads for the unconnected source and/or feedback to disable the amplifier(s) 110 when not connected to the speakers 112/113.

In this simplified speaker multiplexer 50, the control input 51 of the speaker multiplexer(s) 50 is connected to the output 49 of the detector 40. The control input 51 is connected, in this example, to a current driver 52 (e.g., an open collector transistor or equivalent). The current driver 52 drives a relay coil 54. When the output 49 of the detector 40 is in the first state, the current driver 52 energizes the relay 54, thereby changing the relay contacts 56 to route the audio from the amplifier 110 to the speaker 112. When the output 49 of the detector 40 is in the second state, the current driver 52 de-energizes the relay 54, thereby restoring the relay contacts 56 to route the audio from the SPKR-IN to the speaker 112.

Although showing using an electro-mechanical relay 54/56, any known relay or switching circuit is anticipated including, but not limited to, reed-relays, solid state switches, field effect transistors, MOSFETS, etc. Switching systems are well known in the industry and any known switching scheme is anticipated.

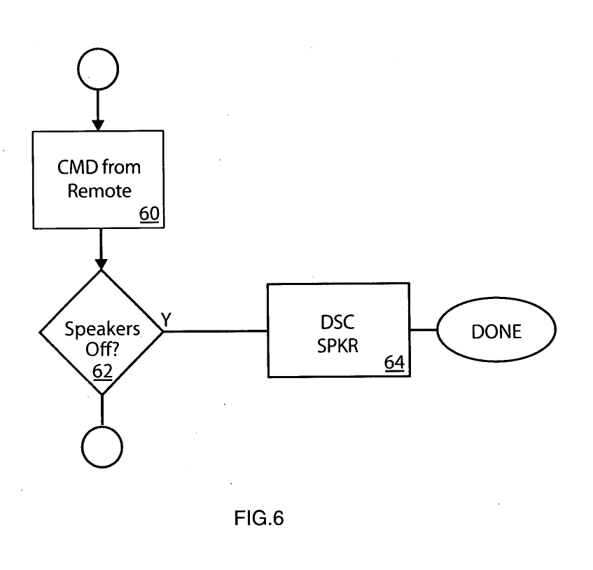

Referring to FIG. 6, a flow chart of the present invention will be described. Many user interfaces are known in the industry and any possible user interface, including an on-screen display or not, is anticipated. In the user interface, a command is received 60 from the remote control 111. For example, a dedicated speaker disable button on the remote control 111 is pressed or the viewer/user maneuvers to an on-screen display having a selection to disable the speakers 112/113. A program running in the processing element 100 determines that the command is a command to disable (e.g., connect to external speaker input SPKR-IN) the speakers 62 and, based on this, changes the output S (see FIG. 2) from the first state to the second state, thereby connecting the speakers 112/113 to the SPKR-IN through the speaker multiplexers 50. A similar program flow is anticipated to enable the internal speakers 112/113 (e.g., connect the internal speakers 112/113 to the amplifier 110 through the multiplexer 50 by changing the output S to the first state).

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for utilizing internal speakers, the system having an internal source of amplified audio and the system having at least one internal speaker, the system comprising:
a means for selectively connecting the at least one internal speaker to either the internal source of amplified audio or an external source of amplified audio, the external source of amplified audio provided as an input to the system; and
a means for controlling the means for selectively connecting.

2. The system for utilizing internal speakers of claim 1, wherein the means for selectively connecting is a speaker multiplexer.

3. The system for utilizing internal speakers of claim 1, wherein the means for controlling includes a processing element, the processing element configured to receive a disable command from a remote control and, responsive to the disable command, the processing element is configured to connect the internal speakers to the external source of amplified audio.

4. The system for utilizing internal speakers of claim 3, wherein the processing element is also configured to receive an enable command from the remote control and, responsive to the enable command, the processing element is configured to connect the internal speakers to the internal source of amplified audio.

5. The system for utilizing internal speakers of claim 1, wherein the means for controlling includes a detector, the detector configured to detect a presence of an audio signal level of an external source of amplified audio and, responsive to the presence of the audio signal level, the detector is configured to control the means for connecting to connect the internal speakers to the external source of amplified audio.

6. The system for utilizing internal speakers of claim 5, wherein the detector is also configured to detect an absence of the audio signal level of the external source of amplified audio and, responsive to the absence of the audio signal level, the detector is configured to control the means for connecting to connect the internal speakers to the internal source of amplified audio.

7. A method of utilizing an internal speaker of a system with an external source of amplified audio, the method comprising:
connecting the internal speaker to an output of a multiplexer;
connecting an internal source of amplified audio to a first input of the multiplexer;
connecting the external source of amplified audio to a second input of the multiplexer;
controlling the multiplexer by a logic signal whereby when the logic signal is in a first logic state the multiplexer connects the internal speaker to the internal source of amplified audio and when the logic signal is in a second logic state, the multiplexer connects the internal speaker to the external source of amplified audio.

8. The method of claim 7, wherein the multiplexer includes a relay having contacts wherein a first common of the contacts is connected to the internal speakers, a second contact of the contacts is connected to the internal source of amplified audio and a third contact of the contacts is connected to the external source of amplified audio.

9. The method of claim 7, wherein the multiplexer includes a solid state relay having a common output connected to the internal speakers, a first input connected to the internal source of amplified audio and a second input connected to the external source of amplified audio.

10. The method of claim 7, wherein the step of controlling includes a step of detecting a presence of a voltage level at the external source of amplified audio and changing the state of the logic signal to the second logic state responsive to the detecting of the presence of the voltage level.

11. The method of claim 7, wherein the step of controlling includes a step of receiving a command from a remote control and responsive to the command, changing the state of the logic signal to the second logic state.

12. The method of claim 11, wherein the step of controlling further includes a step of receiving a second command from the remote control and responsive to the second command, changing the state of the logic signal to the first logic state.

13. A television system comprising:
at least one internal speaker;
an internal source of amplified audio;
at least one multiplexer, each of the multiplexers having an output and at least two inputs, the output connected to one of the at least one internal speaker, a first input of the inputs connected to the internal source of amplified audio and a second input of the inputs connected to an external source of amplified audio, the external source of amplified audio provided as an input to the system; and
a detector, the detector having a detector input connected to the external source of amplified audio, the detector having a detector output connected to the multiplexer,
whereas the detector output controls the multiplexer such that at a first value of the detector output, the multiplexer connects the internal source of amplified audio to one of the at least one internal speaker and at a second value of the detector output, the multiplexer connects the external source of amplified audio to one of the at least one internal speaker.

14. The television system of claim 13, wherein the multiplexer includes a relay.

15. The television system of claim 13, wherein the multiplexer includes a solid state switch.

16. The television system of claim 13, wherein the detector includes a diode, a first lead of the diode connected to the detector input and a second lead of the diode connected to a first lead of a capacitor, whereas a voltage is created over the capacitor when an audio signal is present at the detector input.

17. The television system of claim 16, wherein the detector further includes a Schmitt trigger having an input threshold, an input of the Schmitt trigger is connected to the first lead of the capacitor whereas, when the voltage surpasses the threshold, an output of the Schmitt trigger changes a logic value of the detector output.
